(19) United States
(12) Patent Application Publication
(10) Pub. No.: US 2006/0173953 A1
(43) Pub. Date: Aug. 3, 2006

(54) Product data management method and system

(76) Inventor: Hans Salzsauler, Denzlingen (DE)

Correspondence Address: NATH & ASSOCIATES, 112 South West Street, Alexandria, VA, 22314, US

(21) Appl. No.: 11/048,056

(22) Filed: Feb. 2, 2005

(51) Int. Cl. G06F 15/16; G06F 17/21

(52) U.S. Cl. 709/203; 715/513

(57) ABSTRACT

A PDM method and system is described, wherein documents associated with products are stored in at least one PDM server (2) and data exchange (4, 6, 8, 14, 16) between the at least one PDM server (2) and clients (20, 22, 24, 26) of divisions via at least one interface (46, 47, 48, 49) per division is provided. Tasks are defined (21, 23, 25) for managing product data using a descriptive language. These task definitions are automatically translated (40) into corresponding process execution instructions for clients (20, 22, 24, 26) of the divisions which are concerned by the defined tasks and the interfaces (46, 47, 48, 49) belonging to divisions which are concerned by the defined tasks are automatically configured (42) for according to the defined task necessary data exchange (4, 6, 8, 14, 16, 18) between clients (20, 22, 24, 26) of concerned divisions and the at least one PDM server (2). The PDM system according to the invention provides a configuration engine (140) which is provided for automatically translating the task definitions into corresponding process execution instructions for the clients (120, 122, 124, 126) and automatically configuring the interfaces (146, 147, 148, 149) concerned with the task definition for according to these defined tasks necessary data exchange between clients (120, 122, 124, 126) of the divisions and the PDM server. As descriptive language XML is used preferably. The method as well as the system according to the invention can also be used to provide a PLM or a PDM/PLM method and system.

### BACKGROUND OF THE INVENTION

In every company information has to be managed, whereas this need for information management grows the larger the entity becomes. From a certain point on, the work is usually structured by using projects and relating corresponding data to this project and the concerned product.

In many cases, however, this project and product related data has to be available to several different divisions of the company, e.g. a research division and an administrative division. In these cases it is quite usual to use a product data management (PDM) server, where all the information needed by different divisions of a company or even external divisions or business partners is stored and managed in such way, that every authorized division or business partner has access to this data as a whole or in part, provided the required authorization exists.

In this connection if should be mentioned that the term “product data management” or “PDM” is used differently by persons skilled in the art. The given term might also cover product lifecycle management (PLM) or not. In the following the invention is not literally limited to a PDM method or system if the term “PDM” is used. Alternatively or additionally also a PLM method or system might be covered. If it is explicitly referred to a combined product data and lifecycle management method or system the term “PDM/PLM” is used.

Especially in larger companies the various divisions needing access to PDM data, or the PDM server respectively, use different software systems and/or have different requirements according to the kind and way PDM data is provided to these divisions and/or the kind and way of providing data to the PDM server or other divisions, respectively. Consequently, it is necessary to provide interfaces between the different divisions and the PDM server in order to make it possible to fulfil these needs.

The system currently used for this purpose is schematically shown in FIG. 1 and forms the state of the art in this field. Such systems are for example Allegro® Design Workbench of Cadence Design Systems Inc., DMS of MentorGraphics® Corp. or DS1 of Zuken Corp.

Therein a PDM server 80 is provided which is connected to divisional units, for example an electronic computer aided design (ECAD) divisional unit 90, a business administration unit 91, an assembly/manufacturing unit of the company 92 and an external board supplier 93, whereas these kinds and the number of divisional units serve just as an example.

Due to the reasons mentioned above, however, these divisional units 90 to 93 are not directly connected to the PDM server 80, but via the four individually configured interfaces 81, 82, 83 and 84. The individually configured interface I is connected via a connection 86 to the PDM server 80 and via the connection 95 with the ECAD divisional unit 90. In the same way the individually configured interface II is connected via a connection 87 to the PDM server 80 and via the connection 96 to the business administration unit 91. Similarly, the connection of the individually configured interface III 83 to the PDM server is realized using connection 88 and the connection to the assembly/manufacturing unit 92 is provided by the connection 97. Finally the individually configured interface IV is connected to the PDM server via the connection 89 and to the external board supplier 93 via the connection 98.

All the accessible product related data is stored in the PDM server 80, so that this information is in principle accessible for all divisional units 90 to 93 via their corresponding individually configured interface 81 to 84, unless there is a lack of required authorization. For example, if the ECAD divisional unit 90 has developed or designed a new integrated circuit in a project the related product data, e.g. a part list of required electronic parts, is provided to the PDM server via the connection 95, the individually configured interface I and the connection 86 and finally stored on the PDM server 80. The individually configured interface I 81 is configured in such way that this data exchange between the ECAD divisional unit 90 and the PDM server 80 is possible and that the data is stored on the PDM server 80 in the preferred manner or format.

Now suppose that the external board supplier 93 is in need of data of the ECAD divisional unit 90. In the example given above he needs the part list of the new integrated circuit in order to manufacture a corresponding printed circuit board. Access to the data related to this product is provided by the connection 98, the individually configured interface IV 84 and the connection 89. When transferring the data of the ECAD divisional unit 90 that is stored on the PDM server 80 as a whole or in part to the external board supplier 93, the data is filtered and transformed in the individually configured interface IV 84 in such way to meet the needs of the external board supplier 93 and the system used by him. The individually configured interface IV 84 of course has to be configured in an adequate manner to be able to provide such a transformation or filtering.

Also the other individually configured interfaces 82, 83 have to be configured in similar manners in relation to the data transfer that has to be provided. Such configurations have not only to be performed in connection with the first installation of the system, but every time a new kind of project or product has to be managed where a data transfer is required which is somewhat different from those used in connection with other projects or products. Of course modifications of already existing configurations are also often necessary, as the requirements related to an already existing product or kind of products usually vary with time.

As business processes and related data transfer or data exchange are subjected to rather rapid changes nowadays, related configuration efforts for the different individually configured interfaces are rather costly, particularly as internal or external specialists are needed to do this configuration work. In a consequence, the ration of licence costs for the used software in relation to the additional costs for configuration work is about 1:3. Moreover, the configuration processes are rather time-consuming, in particular if external specialists are required.

Therefore, a need for reduction of configuration costs as well as a reduction of time required for configuration work exists. This needs are addressed by the present invention.

### SUMMARY OF THE INVENTION

The product data management system and method in accordance with the present invention overcome the mentioned limitations and disadvantages. In particular, the configuration costs which rise in connection with the defining of a new task required for the management of a product as well as the time consumption for the configuration of the interfaces are significantly reduced.

The product data management (PDM) method comprises the steps of storing at least one document associated with a product, and optionally with a project, in at least one PDM server; exchanging data between the at least one PDM server and clients of divisions via at least one interface per division; defining tasks for managing product data using a descriptive language; automatically translating defined tasks into corresponding process execution instructions for clients of divisions concerned by at least one defined task; automatically configuring interfaces belonging to divisions concerned by at least one defined task for according to this at least one defined task necessary data exchange between clients of these concerned divisions and the at least one PDM server.

The PDM system according to the invention comprises at least one PDM server; clients of divisions; at least one interface per division connecting the at least one PDM server with at least a part of the clients of the divisions; a configuration engine connected to at least a part of the interfaces and at least a part of the clients of the divisions, whereas the configuration engine is provided for receiving task definitions given in a descriptive language, automatically translating received task definitions into corresponding process execution instructions for at least a part of the clients concerned with received task definitions, automatically configuring at least a part of the interface concerned with at least one received task definition for according to this defined task necessary data exchange between clients of divisions connected to the concerned interfaces and the PDM server.

Using the invention, tasks can be rather easily defined using the descriptive language which can be much more easily understood and used than scripting languages used for the configuration of interfaces. Moreover, these task definitions are automatically translated by the configuration engine and the configurations of interfaces as well as the process execution instructions for the clients are automatically created.

As a consequence, the system can much more easily be configured according to a client's wishes, simultaneously causing significantly less costs. Moreover, less time is needed for additional configuration work or configuration work due to changed requirements. Therefore, the ratio of license costs to additional configuration costs has now turned over using the invention and calculates now as about 3:1. Moreover, less demanding changes or configurations can be realized by the normal user itself.

Furthermore, no additional internal resources are needed for the maintenance of an additional database. The method or the system according to the invention can be integrated directly into the already used PDM system, e.g. SAP®.

In a preferred embodiment of the method according to the invention the tasks are defined using an extended mark up language (XML) as descriptive language. As this language is platform independent, communication between different systems is easier using this language. Moreover, XML is a preferred communication solution for web-based applications. Consequently, in a preferred embodiment of the system according to the invention, the configuration engine is capable of receiving task definitions given in XML as a particular descriptive language.

In another embodiment of the method according to the invention user interfaces for the entering of data are automatically generated in accordance with the defined tasks within at least one interface, whereas in particular graphical user interfaces are generated. In this way, ergonomically advantageous graphical user interfaces can be provided if the corresponding task requires data input by a user.

For this reason in an advantageous embodiment of the system according to the invention the configuration engine is capable of automatically generating user interfaces according to defined tasks within at least one interface, particularly graphical user interfaces, for the entering of data.

In a further improvement of the method according to the invention the data entered in at least one user interface is stored and displayed as preselection data, or preselection values respectively, when this at least one user interface is invoked the next time, so that the user instantaneously knows which data has been entered by him the last time he dealt with the managing of the same kind of data.

Therefore, in an improvement of the system according to the invention the data entered in at least one user interface is stored and displayed as pre-selected data the next time this at least one user interface is invoked.

An improved method according to the invention further comprises the managing of product related lifecycles (PLM) and corresponding data in the same way as the documents associated with this product. In this way product lifecycles can be managed in the same way as product data using the same method and system. Configuration can again be provided by defining tasks which are automatically translated by the configuration engine, so that the configuration interfaces can be automatically configured and process execution instructions for the clients can be automatically generated.

In an advantageous embodiment of the system according to the invention a product lifecycle management server is therefore bi-directionally connected to the at least one PDM server or integrated in the at least one PDM server.

In a preferred embodiment of the system according to the invention, the task definitions are made in at least one client of at least one divisional unit, so that no further terminal or computing device has to be provided for the definition of tasks.

Furthermore, in an advantageous system according to the invention at least a part of the interfaces is integrated into the at least one PDM server. This results in a compact PDM system with short connections between the interfaces and the PDM server.

For the same reason in an improved system according to the invention the configuration engine is integrated into the at least one PDM server, so that the numbers of terminals or computing devices can be reduced. Consequently, maintenance for less devices has to be provided.

In another advantageous embodiment of the system according to the invention at least a part of the interfaces is formed by web servers, which are connected to the at least one PDM server. This makes it possible to provide a configuration of the individual web server which is valid for all clients related to this web server, or interface respectively, so that not each of the clients has to be configured. In this way the efforts for installation, maintenance-and deployment of the system are minimized.

### BRIEF DESCRIPTION OF THE DRAWINGS

FIG. 1 is a PDM system according to the state of the art.

FIG. 2 schematically illustrates a preferred embodiment of the method according to the invention.

FIG. 3 schematically illustrates another preferred embodiment of the method according to the invention.

FIG. 4 shows a schematic drawing of a preferred embodiment of a PDM system according to the invention.

FIG. 5 schematically shows another preferred embodiment of the system according to the invention.

FIG. 6 shows in detail yet another preferred embodiment of a system according to the invention which is 3-tier web based.

FIG. 7 shows a graphical user interface together with entered data or pre-selected data, respectively.

FIG. 8 is a diagram of the element “CONFIGS” of the XML definition language.

FIG. 9 is a diagram of the element “CONFIGS/CONFIGMASTER” of the XML definition language.

FIG. 10 is a diagram of the element “CONFIGS/CONFIGMASTER/PARAMS” of the XML definition language.

FIG. 11 is a diagram of the element “CONFIGS/CONFIGMASTER/STATE” of the XML definition language.

FIG. 12 is a diagram of the element “CONFIGS/CONFIGMASTER/STATE/SIMPLETASK” of the XML definition language.

FIG. 13 is a diagram of the element “CONFIGS/CONFIGMASTER/STATE/VARIANTTASK” of the XML definition language.

FIG. 13a shows a selection window for variants.

FIG. 14 is a diagram of the element “CONFIGS/CONFIGMASTER/STATE/SIMPLETASK/DISPSTEPS” of the XML definition language.

FIG. 15 is a diagram of the element “CONFIGS/CONFIGMASTER/STATE/SIMPLETASK/EXESTEPS” of the XML definition language.

FIG. 16 is a diagram of the element “CONFIGS/CONFIGMASTER/STATE/SIMPLETASK/PARAMS” of the XML definition language.

FIG. 17 is a diagram of the element “CONFIGS/CONFIGMASTER/STATE/VARIANTTASK/DISPSTEPS” of the XML definition language.

FIG. 18 is a diagram of the element “CONFIGS/CONFIGMASTER/STATE/VARIANTTASK/EXESTEPS” of the XML definition language.

FIG. 19 is a diagram of the element “CONFIGS/CONFIGMASTER/STATE/VARIANTTASK/PARAMS” of the XML definition language.

FIG. 20 is a diagram of the element “DISPSTEPSType/STEP” of the XML definition language.

FIG. 21 is a diagram of the element “EXESTEPSType/STEP” of the XML definition language.

FIG. 22 is a diagram of the element “PARAMSType/PARAM” of the XML definition language.

FIG. 23 is a diagram of the element “PARAMSType/PARAM/VALUE” of the XML definition language.

FIG. 24 is a diagram of the element “STEPType/STEPS” of the XML definition language.

FIG. 25 is a diagram of the element “STEPType/STEPS/STEP” of the XML definition language.

FIG. 26 shows a diagram of the complex type “DISPSTEPSType” of the XML definition language.

FIG. 27 shows a diagram of the complex type “EXESTEPSType” of the XML definition language.

FIG. 28 shows a diagram of the complex type “PARAMSType” of the XML definition language.

FIG. 29 shows a diagram of the complex type “STEPType” of the XML definition language.

FIG. 30 shows a task definition for the generation of a part list using XML as descriptive language.

FIG. 31 schematically shows steps necessary to perform a sample task that has been defined using the XML definition language of FIGS. 8 to 29.

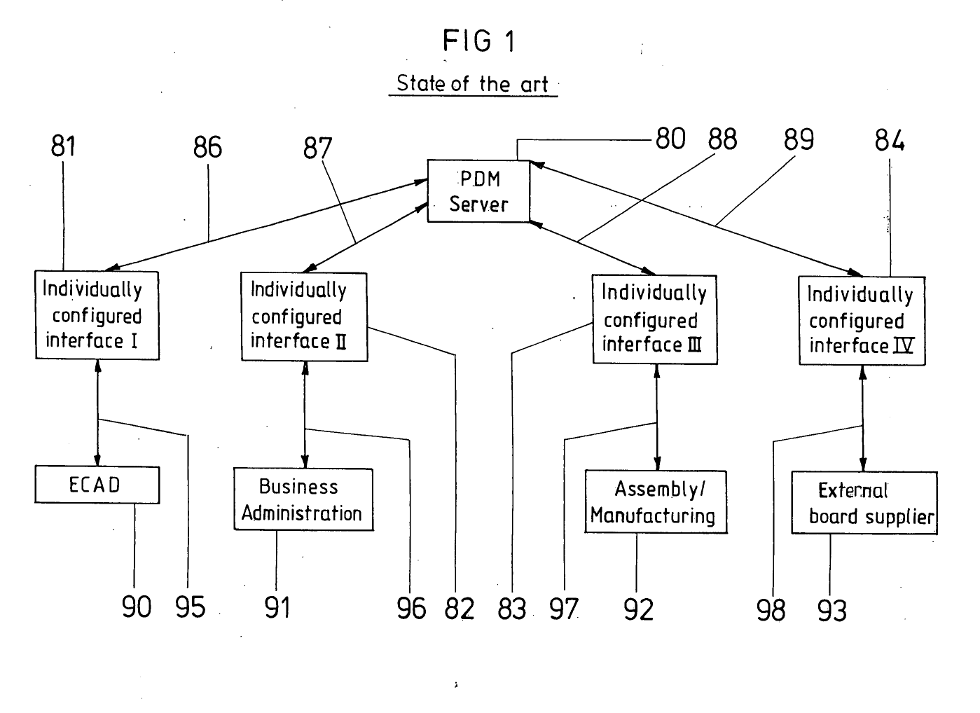

### DESCRIPTION OF PREFERRED EMBODIMENTS

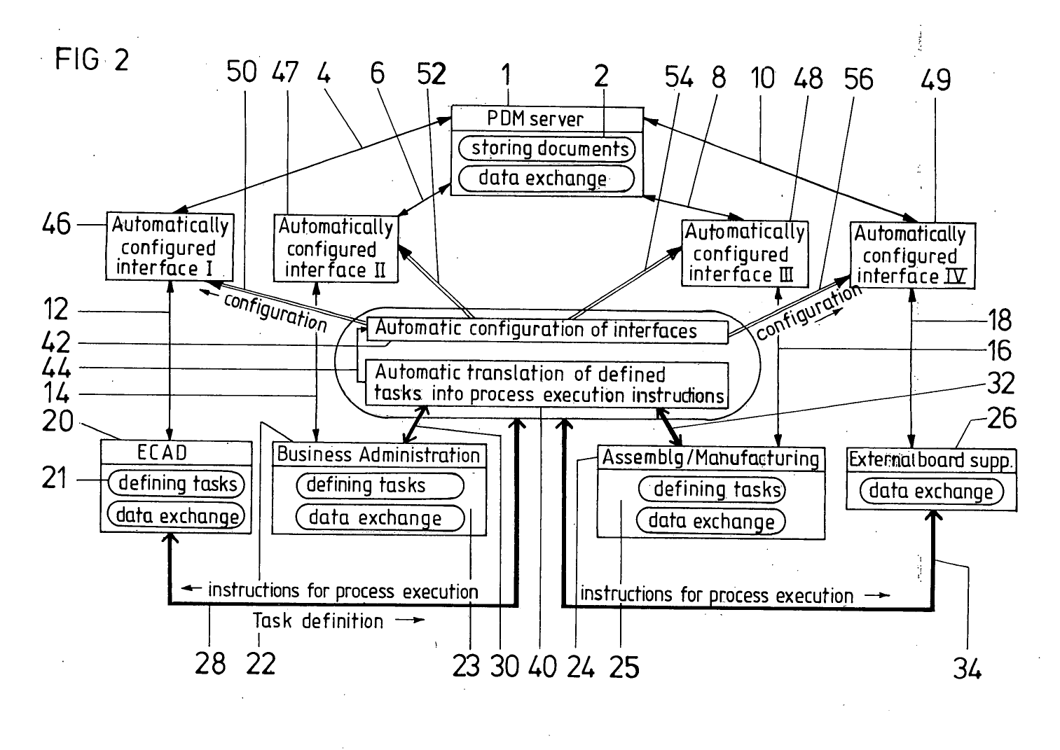

FIG. 2 schematically shows a preferred embodiment of the method according to the invention. Product related data is stored 2 on a PDM server 1. Data is exchanged between the PDM server 1 and the automatically configured interface I 46 as indicated by the arrow 4. Furthermore, data exchanges 6,8,10 are provided between the PDM server 1 and the individually configured interfaces II, III and IV 47, 48, 49. Moreover, a data exchange 12 is provided between the automatically configured interface I 46 and a client 20 of a division ECAD. Similarly, data exchanges 14, 16 and 18 are provided between the automatically configured interface II 47 and a client 22 of a division business administration, between the automatically configured interface III 48 and a client 24 of a division assembly/manufacturing and between the automatically configured interface IV 49 and a client 26 of an external board supplier.

In this way the clients 20, 22, 24 and 26 of the divisions can obtain data from the PDM server 1 via the different automatically configured interfaces 46, 47, 48 and 49. Vice versa, they can provide data to the PDM server 1 via the different automatically configured interfaces 46, 47, 48 and 49 for storing this data or corresponding documents in a product related way on the PDM server 1. I. e. the data exchanges 4, 6, 8, 10, 12, 14, 16 and 18 given in FIG. 2 are all bi-directional. However, they might also be at least partially uni-directional, if data has to be transferred only in one direction.

Moreover, also a greater number of divisions and automatically configured interfaces or PDM servers might be provided.

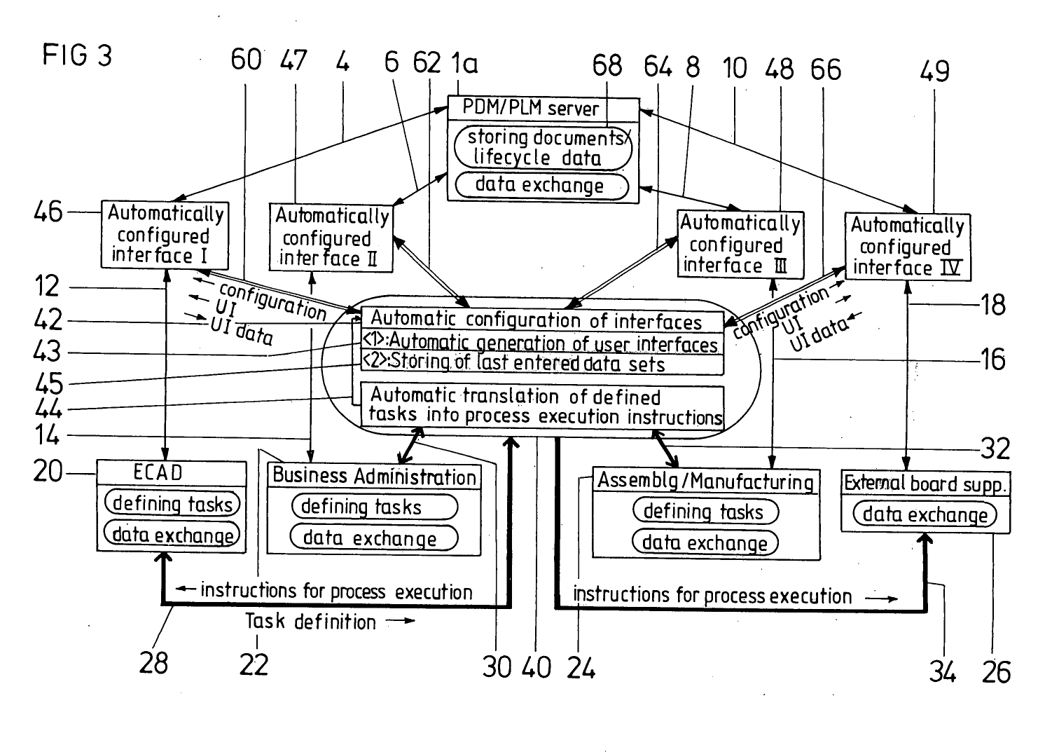

These remarks regarding the bi-/uni-directionality of data exchange and the number of divisions, PDM servers and of automatically configured interfaces are true also for the embodiments of the invention given in FIGS. 3 to 5.

As described above, the various divisions needing access to PDM data or providing PDM data to the PDM server 1 might have different requirements according to the kind and way PDM data is provided to the divisions or the clients 20, 22, 24 or 26 respectively, and/or the kind and way of providing data to the PDM server 1 or the clients of other divisions. In order to fulfil these needs, the interfaces between the divisions and the PDM server 1 have to be configured in an appropriate way.

In a first step in a method according to the invention tasks are defined 21, 23, 25 for managing product data in the required ways. In the embodiment given in FIG. 2 this definition of tasks 21, 23 and 25 can be done in the clients 20, 22, 24 of the divisions ECAD, business administration and assembly/manufacturing. No possibility for defining tasks is provided within the client 26 of the external board supplier. This is just for illustrating the fact, that not every division requires the possibility for defining tasks. In principle one such possibility is sufficient. Nevertheless, every division, or corresponding clients respectively, might of course provide the possibility of defining tasks.

As shown in FIG. 2, the task definitions are transferred 28, 30, 32 and used as input for an automatic translation 40 of defined tasks into process execution instructions. In turn, the process executions instructions are transferred 28, 30, 32 to the clients 20, 22, 24 of the different divisions providing the possibility of defining tasks 21, 23 and 25. As in the example of FIG. 2 client 26 of the external board supplier provides no possibility for defining tasks, only instructions for process execution are transferred 34 to this client.

Obviously, it is sufficient to transfer instructions for process execution only to those clients 20, 22, 24, 26 which are concerned by the automatically translated defined tasks.

As illustrated by the forwarding 44 of task definitions, an automatic configuration 42 of the interfaces 46, 47, 48 and 49 is created on the basis of the task definitions. The resulting configurations are transferred 50, 52, 54, 56 to the automatically configured interfaces 46, 47, 48 and 49, and as their name already states, are automatically configured according to the automatic configurations obtained on the basis of the task definitions.

The definition of tasks is realized using a descriptive language, preferably XML, so that simple tasks can be defined by an end user itself without a need for a specialist in this field. The configuration of the interfaces according to the requirements is done automatically, so that the end user has not to care about this complicated, time consuming step. Moreover, the clients 20, 22, 24, 26 of the different divisions are provided 28, 30, 32, 34 with instructions for process execution in such way that the task defined by the end user can be realized by process execution without additional configuration work of the end user itself.

Another preferred embodiment according to the method according to the invention is schematically shown in FIG. 3 and based on the embodiment discussed above. Therefore, corresponding elements have the same reference numbers.

In contrast to FIG. 2, the interfaces 46, 47, 48 and 49 are not only automatically configured, but also user interfaces are automatically generated 43 and provided 60, 62, 64, 66 to the automatically configured interfaces 46, 47, 48 and 49.

In turn, if data is entered into the user interface (UI), the storing of the last entered data set 45 is provided. Hence, the transfer of configurations and user interface data 60, 62, 64, 66 is in contrast to FIG. 2 in a certain way bi-directional.

As a further contrast to the method given in FIG. 2, the method illustrated in FIG. 3 provides not only the storing of product related documents, but the storing of product related documents and product related lifecycle data 68 in a PDM/PLM (product lifecycle management) server 1a. Lifecycle data can consequently be managed using the method schematically depicted in FIG. 3 in the same way as described above for the case of conventional product related documents or data.

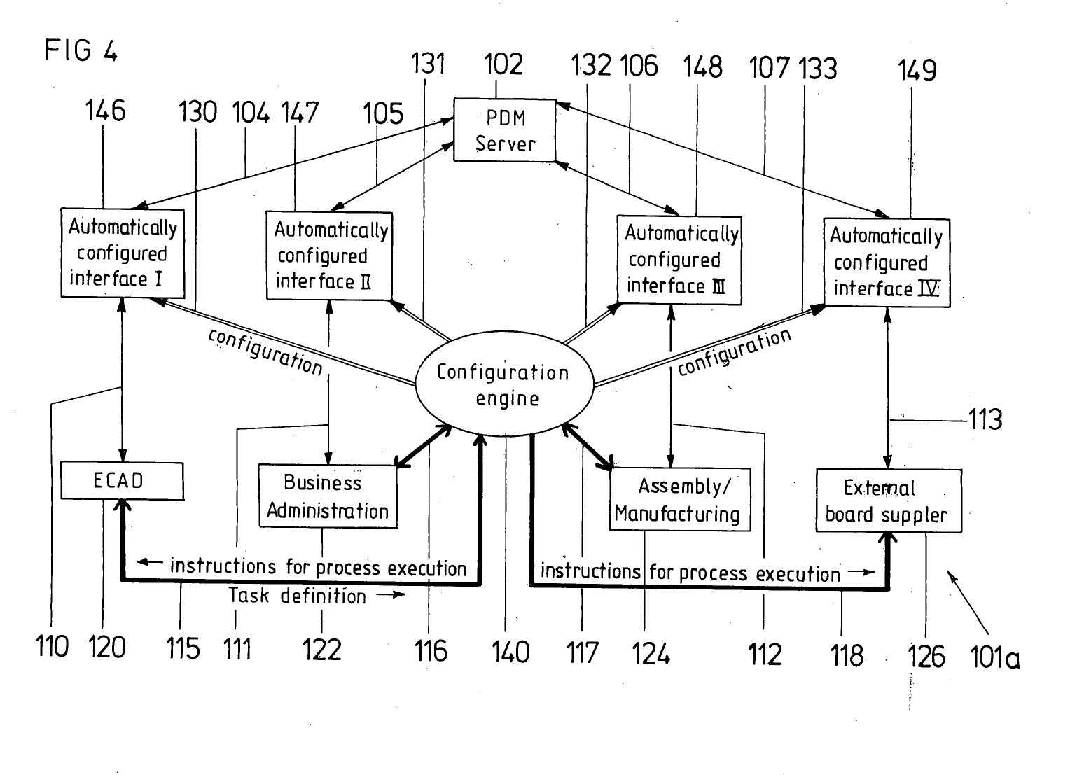

FIG. 4 shows a preferred embodiment of a PDM system 101a according to the invention. Therein, a PDM server 102 is connected via a connection 104 to an automatically configured interface I 146, via a connection 105 to the automatically configured interface II 147, via a connection 106 to the automatically configured interface III 148 and via the connection 107 to the automatically configured interface IV 149.

Furthermore, the automatically configured interface I 146 is connected to a client 120 of the division ECAD via the connection 110, the automatically configured interface II 147 is connected to the client 122 of the division business administration via the connection 111, the automatically configured interface III 148 is connected to a client 124 of the division assembly/manufacturing and the automatically configured interface IV 149 is connected to a client 126 of the division external board supplier via the connection 114.

Preferably, the connections 104, 105, 106, 107, 110, 111, 112 and 113 are bi-directional connections as indicated by the arrows at each end of the corresponding lines. In this way the PDM server 102 is by-directionally connected to the clients 120, 122, 124 and 126 of the different divisions via the automatically configured interfaces 146, 147, 148 and 149, so that a bi-directional data exchange between these elements is possible.

Moreover, a configuration engine 140 is provided which is connected to the client 120 of the division ECAD via the connection 115 to the client 122 of the division business administration via the connection 116, to the client 124 of the division assembly/manufacturing via the connection 117 and to the client 126 of the division external board supplier via the connection 118.

The connections 115, 116 and 117 are bi-directional connections which make it possible to provide task definitions originating from one of the clients 120, 122, 124 to the configuration engine 140 and receiving in turn instructions for process execution from the configuration engine. The connection 118 instead, is uni-directional in that way, that data can only be transferred in the single direction from the configuration engine 140 to the client 126 of the external board supplier. However, this is just for illustration reasons and the connection 118 could also be a bi-directional connection if required.

The configuration engine 140 is capable of automatically translating task definitions received via the connections 115, 116 or 117 into process execution instructions corresponding to these task definitions for those clients 120, 122, 124, 126 concerned with received task definitions. The resulting instructions for process execution can be transferred via the connections 115, 116, 117 and 118 to the clients 120, 122, 124, 126 of the different divisions, so that processes appropriate for the realization of the defined tasks can be executed on those clients.

Furthermore, the configuration engine is provided for automatically configuring the interfaces 146, 147, 148 and 149 in accordance with the received task definitions so that necessary data exchange between clients 120, 122, 124, 126 of different divisions or with a PDM server 102 is possible in accordance with specific requirements.

The described automatic configuration of the interfaces 146, 147, 148 and 149 by the configuration engine is illustrated in FIG. 4 by the connections 130, 131, 132 and 133.

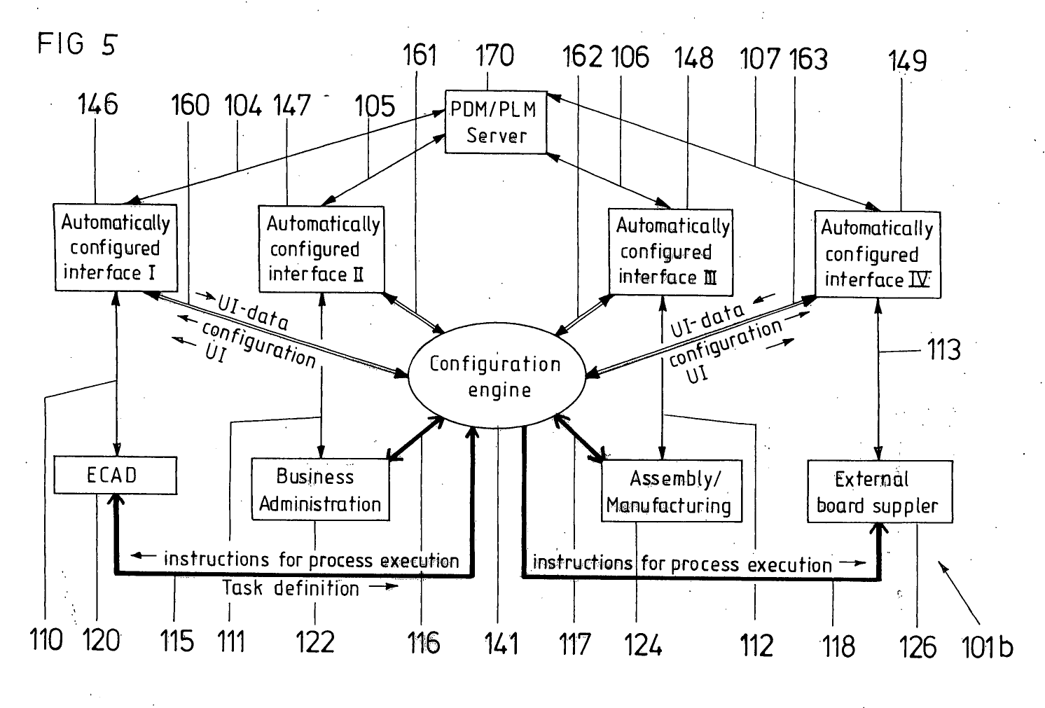

FIG. 5 shows another preferred embodiment of the system according to the invention which is based on the system depicted in FIG. 4. Consequently, corresponding elements have the same reference numbers.

As a contrast to the embodiment of FIG. 4 the connections 160, 161, 162 and 163 illustrate the additional capability of a configuration engine 141 to automatically generate user interfaces (UI) according to defined tasks, particularly graphical user interfaces, for the entering of data within the interfaces 146, 147, 148 and 149.

Moreover, these connections 160, 161, 162 and 163 are bi-directional in such way that a specific set of data entered in the user interfaces, preferably the last entered data set, can be handled by the configuration engine 141 in such way, that it is stored and displayed as pre-selection data the next time the user interface is invoked again.

In the PDM system 101b of FIG. 5 the PDM server 102 is replaced by a combined PDM/PLM server, whereas PLM stands for product lifecycle management. In this way the PDM system 101b is additionally capable of managing product related product lifecycle data, or product lifecycles respectively, in the same way as product related documents or data the system 101a deals with exclusively, whereas, as mentioned in the introduction, the system 101a might also deal exclusively with the management of product lifecycle data. Instead of a combined PDM/PLM server 170 of course separated PDM and PLM servers could be provided which are adequately connected to each other and to other components of the system 101b. However, the integration of the PLM server in the PDM server is advantageous in that way that no additional hardware is needed.

Obviously, the clients 120, 122, 124, 126 as well as the corresponding divisions and the interfaces 146, 147, 148, 149 or the PDM server, or PDM/PLM server respectively, are not limited to the numbers depicted in FIGS. 4 or 5. Their numbers can of course be adapted to the specific needs of the projects or products that have to be managed.

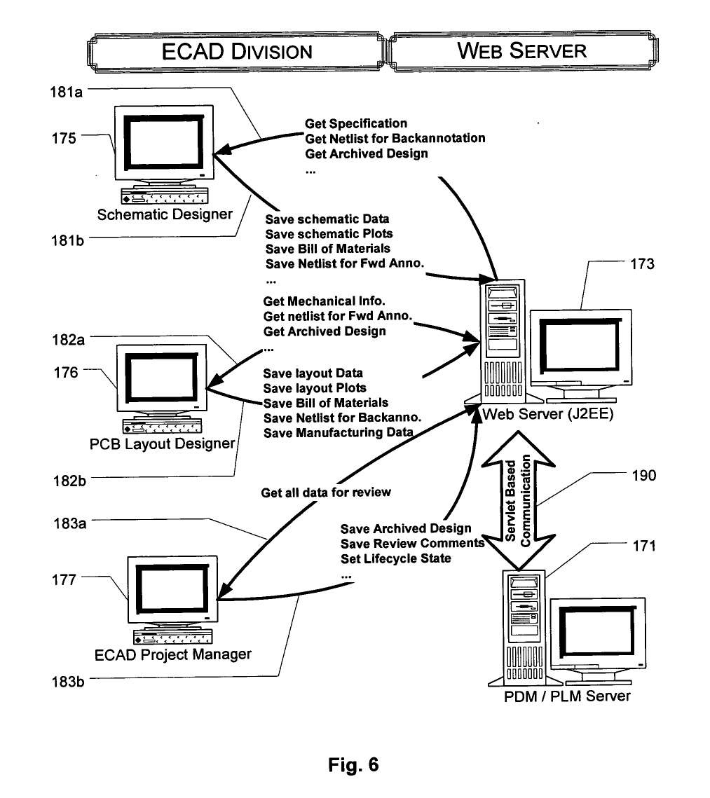

FIG. 6 illustrates the use of a web-server 173 as interface between the ECAD division and a PDM/PLM server 171. In the depicted embodiment the connection between the web-server 173 and the PDM/PLM server 171 is formed by a servlet based communication 190. In the example given in FIG. 6 the ECAD division is formed by a client 175 of a schematic designer, a client 176 of a printed circuit board (PCB) layout designer and a client 177 of an ECAD project manager.

For illustration reasons, examples for possible communications between the clients 175, 176, 177 and the PDM/PLM server 171 via the web-server 173 are given. In order to visualize the different steps of receiving data and providing data the connections from clients 175, 176, 177 to the web-server 173 are split into connections for obtaining data 181a, 182a, 183a and for providing data 181b, 182b, 183b. Obviously, each pair of different connections, as e.g. the connections 181a and 181b, can be replaced by one bi-directional connection.

In detail, the client 175 of the schematic designer might get specifications, net lists for back annotation, archived designs, etc. In turn, the client 175 of the schematic designer might provide schematic data, schematic plots, bills of materials, net lists for forward annotation, etc. to the web-server 173 via the connection 181b, and consequently to the PDM/PLM server 171.

The client 176 of the PCB layout designer might for example get mechanical information for the required boards, net lists for forward annotation, archived designs, etc. via the connection 182a from the web server or the PDM/PLM server respectively. In turn it might provide layout data, layout plots, builds of materials, net lists for back annotations, manufacturing data, etc. via the connection 181b to the web-server which will again function as interface and provide appropriately filtered or prepared data to the PDM/PLM server 171 via the connection 190.

Finally, client 177 of the ECAD project manager might get all project or product related data for review via the connection 183a from the web-server 173, which fetches the required data in the preferred format from the PDM/PLM server 171. In turn, the client 177 of the ECAD project manager might provide archive designs, review comments, etc. via the connection 183 and via the web-server 173 functioning as interface to the PDM/PLM server 171. Moreover, the ECAD project manager might for example set life cycle states for the project or product in this way by providing corresponding data to the PDM/PLM server 171.

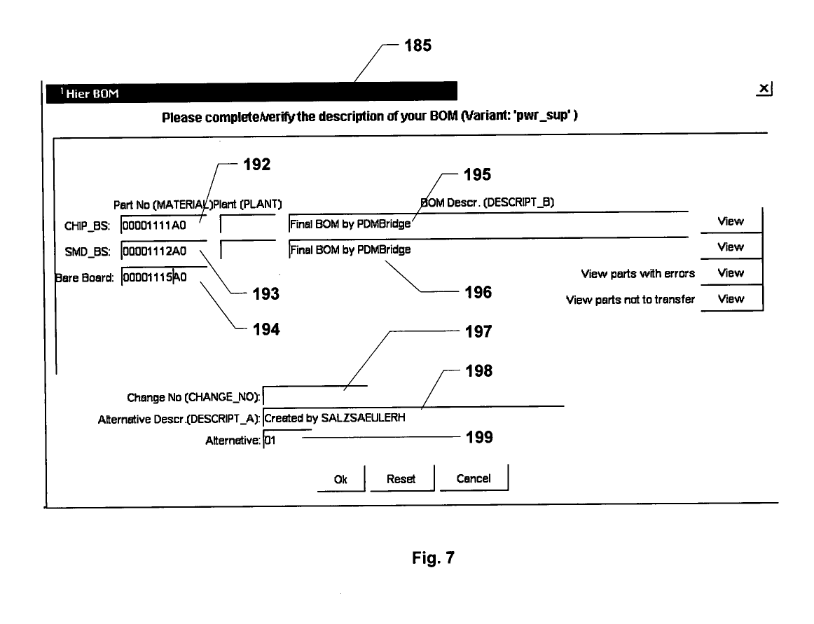

FIG. 7 shows an example of an user interface, or more specific a graphical user interface 185. This graphical user interface 185 comprises editable fields 192, 193, 194, 195, 196, 197, 198 and 199 which can be edited by the end user.

FIG. 7 depicts the graphical user interface 185 instantaneously after its invocation, e. g. before any data has been entered. The data shown in the editable fields 192-196 as well as in the fields 198 and 199 is data that has been entered when the graphical user interface 185 has been used last time and is displayed as pre-selection values. In contrast to that, in the editable field 197, no pre-selected value is given; either because this is not wanted or because no value has been entered when the graphical user interface 185 had been used last time.

According to the invention, tasks are defined using a descriptive language, preferably XML. In the following, an embodiment of such an XML descriptive language is discussed. Table 1 gives a survey of the elements and complex types of an XML descriptive language according to the invention.

TABLE 1
Elements and complex types of XML descriptive
language

| Elements | Complex types |
|---|---|
| CONFIGS | |
| CONFIGMASTER | |
| PARAMS | PARAMSType |
| STATE | |
| VARIANTTASK | |
| SIMPLETASK | |
| DISPSTEPS | DISPSTEPSType |
| EXESTEPS | EXESTEPSType |
| STEP | STEPType |
| PARAM | |
| COMMENT | |

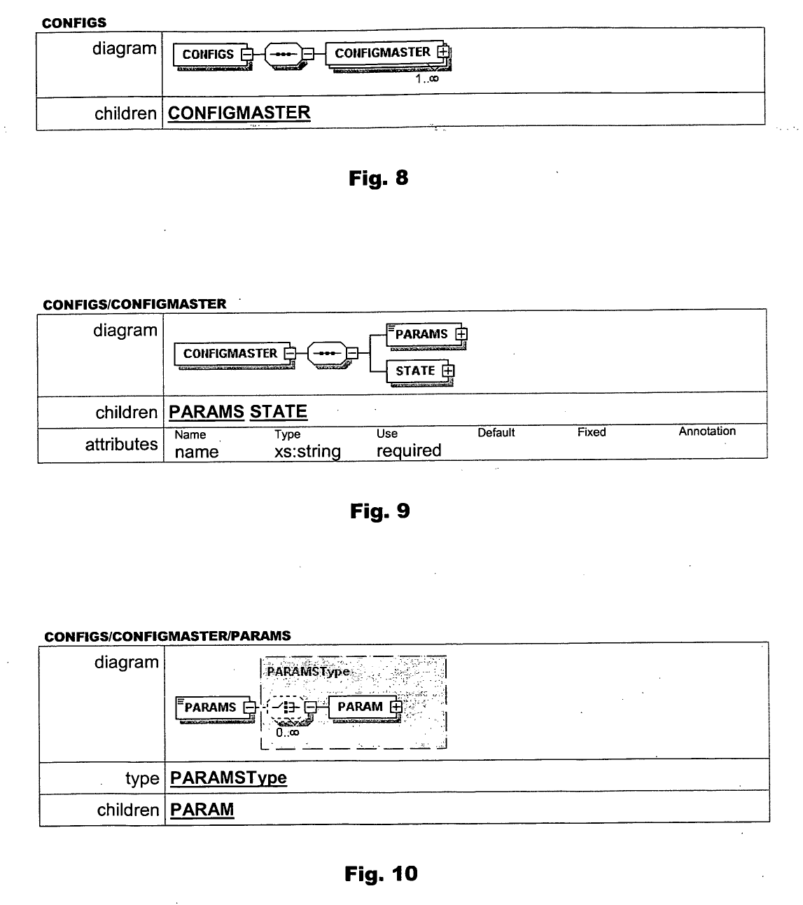

Further information about this specific embodiment of a descriptive XML language gives the structure diagram of FIGS. 8-29.

FIG. 8 shows a diagram of the element CONFIGS which has the child CONFIGMASTER.

The XML node CONFIGS represents the XML syntactical outer frame to embed collections of task definition lists. Purpose here is to provide lists of task definitions to perform for different scopes—as are for example tasks to be performed by schematics engineers, tasks to be performed by layout engineers, tasks to be performed by project managers, etc.

FIG. 9 depicts a diagram of the element CONFIGS/CONFIGMASTER together with its children PARAMS and STATE. Moreover, the attributes of this element are given.

The XML node CONFIGMASTER represents the XML syntactical outer frame to embed the state specific list of task definitions or as well a list of parameters that might be accessed from within lower level nodes.

A diagram of the element CONFIGS/CONFIGMASTER/PARAMS, which is of the type PARAMSType and has the child PARAM, is given in FIG. 10.

The XML node PARAMS represents the XML syntactical outer frame to embed a list of parameters. The purpose of these parameters is similar to the usage of variables in a standard programming language. In general parameters are divided into persistent and volatile types because some of the parameters that are predefined are tightly coupled to the selected product or project, the local environment or the customers PDM/PLM system and should not be changeable by the interface (like operating system user name, PDM/PLM user name, selected project or product name, etc.)

Parameters defined in the above scope, (directly inside the CONFIGMASTER) frame can be regarded as global variables.

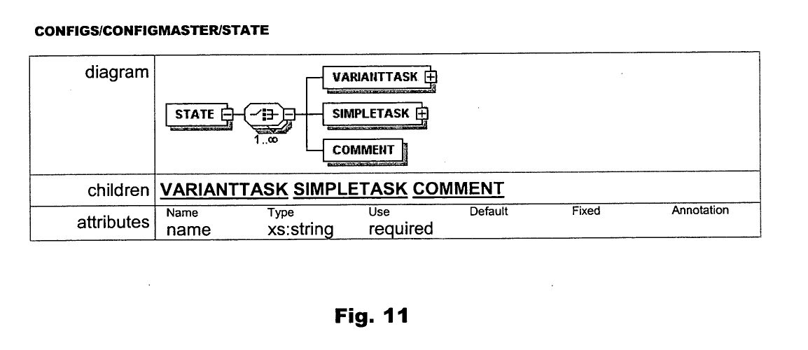

In FIG. 11, a diagram of the element CONFIGS/CONFIGMASTER/STATE and its children VARIANTTASK, SIMPLETASK and COMMENT and provided attributes are shown.

The XML node STATE represents the XML syntactical outer frame to embed a list of tasks. The reason for this sub node state is the ability to provide different sets of task definitions to perform according to the current life cycle state of a product in the customers PLM system.

This might, for example, be the product or project dependant transfer of a schematic design, the transfer of a set of plot files and/or manufacturing data/instructions to the customers PLM system for products or projects in state “Work In Process” or state “Start Project Work”, the product dependant extraction of schematic or layout data for a product in state “Rejected”, the extraction of any schematic or layout data for a product in state “Released” in addition of creating a new product or project revision in state “Work in Process”, . . . (May be configured according to the lifecycles used in the customers PLM system).

Due to the fact of the ability of one electronic design to lead to several products (assembly variants) the tasks to perform are separated into SIMPLETASK (for variant independent file sets) and VARIANTTASK (for variant related file sets).

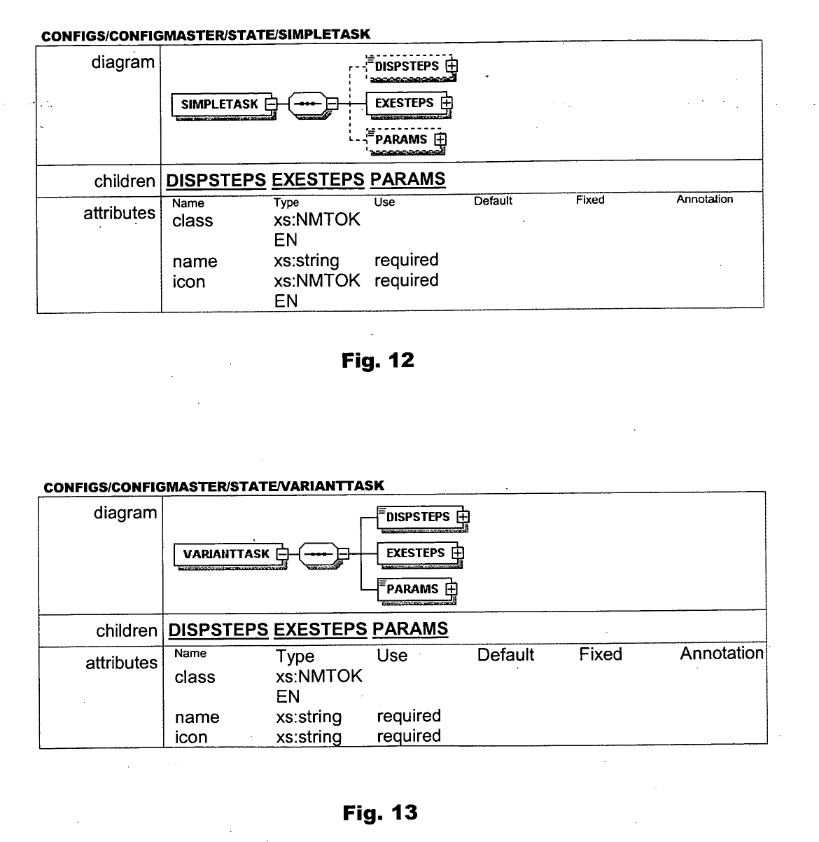

The structure diagram of the element CONFIGS/CONFIGMASTER/STATE/SIMPLETASK is given in FIG. 12 together with its children DISPSTEPS, EXESTEPS and PARAMS and its attributes.

The XML node SIMPLETASK represents the XML syntactical outer frame to embed the single steps to fulfill the actual variant independent task. In addition the task itself is visualized using the value of attribute “name” (e.g. “Save Design”) and optionally an icon (e.g. “checkinicon.gif”). The attribute class is reserved for future enhancements and will currently be ignored. Despite of the task type VARIANTTASK (please see below), the task type SIMPLETASK is designed to be used to fulfill design product or project related tasks which are variant independent tasks as for example saving a design, saving manufacturing information for a bare (unassembled) board, etc.

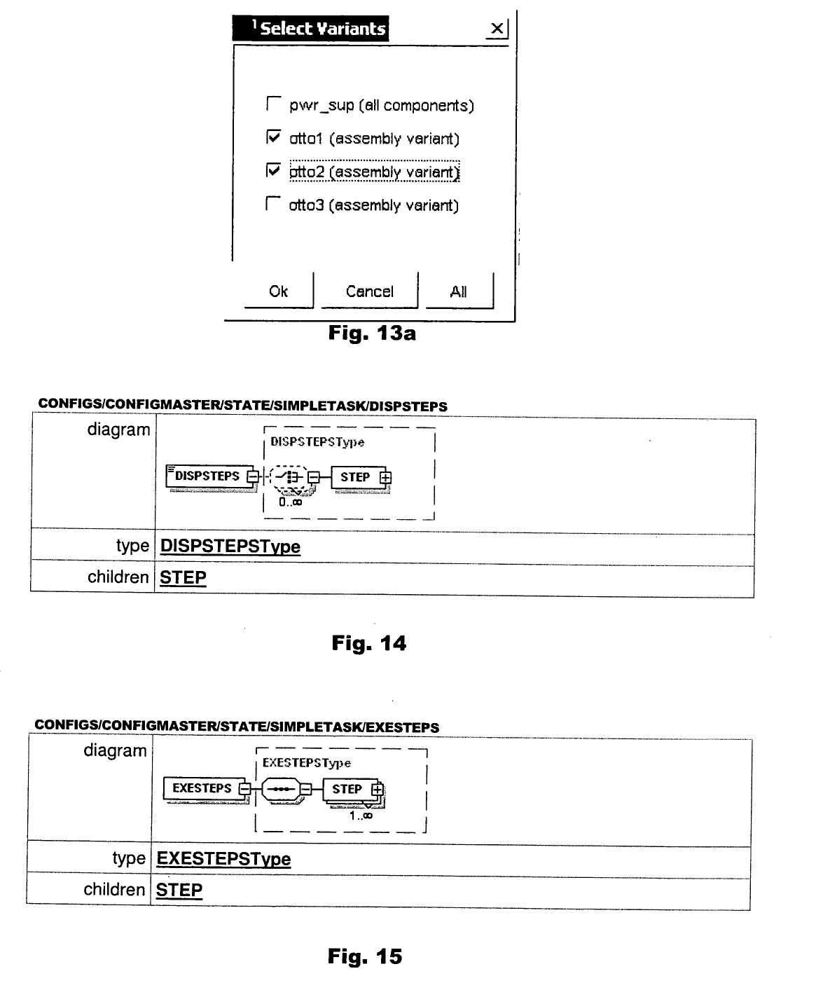

FIG. 13 shows a diagram of the element CONFIGS/CONFIGMASTER/STATE/VARIANTTASK together with its children DISPSTEPS, EXESTEPS and PARAMS and its attributes.

The XML node VARIANTTASK therein represents the XML syntactical outer frame to embed the single steps to fulfill the actual variant dependent task. In addition, the task itself is visualized using the value of the attribute “name” (e.g. “Prelim BOM”) and optionally an icon (e.g. “bomicon.gif”). The attribute class is reserved for future enhancements and will currently be ignored. Despite of the task type SIMPLETASK (please see above) The task type VARIANTTASK is designed to be used to fulfill variant related tasks. Therefore, when attempting to execute a variant dependent task the first thing a user has to do is to select the variant or a list of variants that should be processed. FIG. 13a shows a selection window for the selection of these variants.

The list of steps that has to be performed according to the task definition will then be executed for each selected variant.

Typical variant related tasks can be the creation and transfer of a parts list, the creation and transfer of variant related plot files and/or assembly files, the transfer of variant related manufacturing instructions, etc.

Three different XML nodes that may be described beneath a VARIANTTASK object are DISPSTEPS, which is a list of steps for visualizing existing information from the PLM system, EXESTEPS, which is a list of steps to create and to transfer data, and PARAMS which is a parameter list to control each single step.

FIG. 14 shows a diagram of the element CONFIGS/CONFIGMASTER/STATE/SIMPLETASK/DISPSTEPS, which is of the type DISPSTEPSType and provides the child STEP.

The XML node DISPSTEPS represents the XML syntactical outer frame to embed the single steps for visualizing existing product related information from within the customers PLM system. Using this kind of steps in a reasonable manner data to be displayed should be related to the actual selected task (though this is not mandatory). Any kind of data may be visualized using the appropriate Java Plugin Classes. Nevertheless, the display of data and the status related to the currently selected task is the most useful way of operation.

FIG. 15 depicts a diagram of the element CONFIGS/CONFIGMASTER/STATE/SIMPLETASK/EXESTEPS, which is of the type EXESTEPSType and provides also a child STEP.

The XML node EXESTEPS defines the outer frame for the definition of a sequence of steps that are necessary to fulfill the current task. Typically the creation of data from the actually work on design should reside in here. Therefore, here is the place to create plots, parts lists, zipped archives or any other derived outputs.

It might for example be used for creating a BOM (bill of material/parts list) in the following way:
1.) create a BOM from the currently selected design in a readable format.
2.) Gather information from the user regarding e.g. BOM name, BOM type, BOM version, BOM usage or BOM alter native
3.) Check the existence of the BOM in PLM in order to determine whether to create a new BOM or whether to change an existing BOM
4.) Check the existence of all components used in the BOM in PDM/PLM
5.) Transfer the created BOM to PDM/PLM.

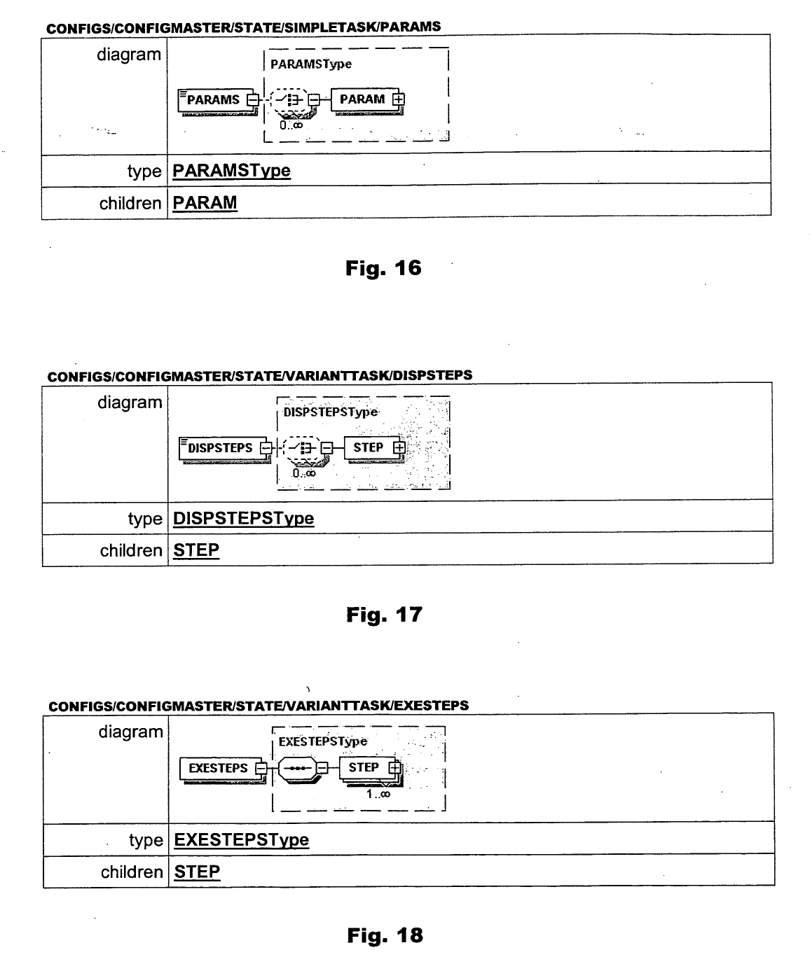

FIG. 16 shows a diagram of the element CONFIGS/CONFIGMASTER/STATE/SIMPLETASK/PARAMS which is of the type PARAMSType and provides a child PARAM.

The XML node PARAMS defines the outer frame for the definition of single parameters and/or attributes to be used by the Java Plugin Classes configured in the single steps.

FIG. 17 depicts a diagram of the element CONFIGS/CONFIGMASTER/STATE/VARIANTTASK/DISPSTEPS, which is of the type DISPSTEPSType and provides the child STEP. The corresponding description is the same as for the element CONFIGS/CONFIGMASTER/STATE/SIMPLETASK/DISPSTEPS.

In FIG. 18, a diagram of the element CONFIGS/CONFIGMASTER/STATE/VARIANTTASK/EXESTEPS, which is of the type EXESTEPSType and provides the child STEP and can be characterized in the same way as the element CONFIGS/CONFIGMASTER/STATE/SIMPLETASK/EXESTEPS.

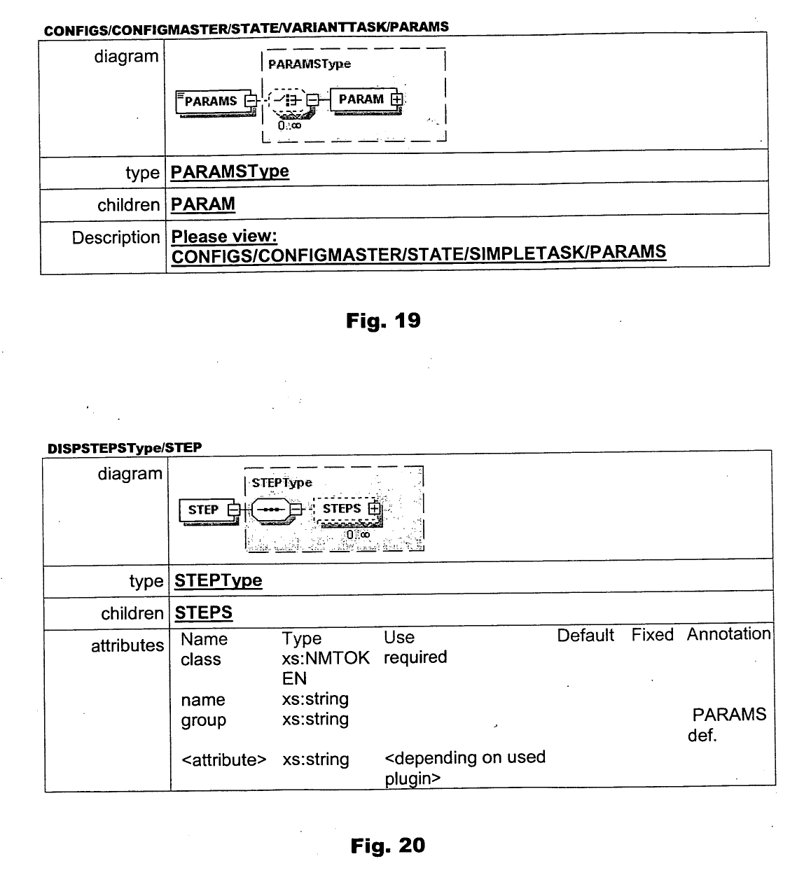

FIG. 19 depicts a diagram of the element CONFIG/CONFIGMASTER/STATE/VARIANTTASK/PARAMS, which is of the type PARAMSType and provides the child PARAM. This element can be described in the same way as the element CONFIGS/CONFIGMASTER/STATE/SIMPLETASK/PARAMS above.

In FIG. 20, a diagram of the element DISPSTEPSType/STEP is given together with its attributes. The element DISPSTEPSType/STEP if of the type STEPType and provides the child STEPS.

The XML node STEP represents one step to fulfill a task. The single steps are processed in a sequential manner. The work sequence will interrupt and exit in case of a serious error returned from one of the executed steps. The mandatory token “class=<value>” defines the name of the Java Plugin class to be used to perform this step. The optional token “name=<value>” may define an internal name for the step that is used for log and debug messages. The optional token “group=<value>” references parameter definitions that are assigned to the same group. Consequently parameter definitions may be adjusted towards specific single steps that require a specific set of attributes/parameters.

FIG. 21 shows a diagram of the element EXESTEPSType/STEP together with its attributes. This element is of the type STEPType and provides the child STEPS and is characterized in the same way as the element DISPSTEPType/Step.

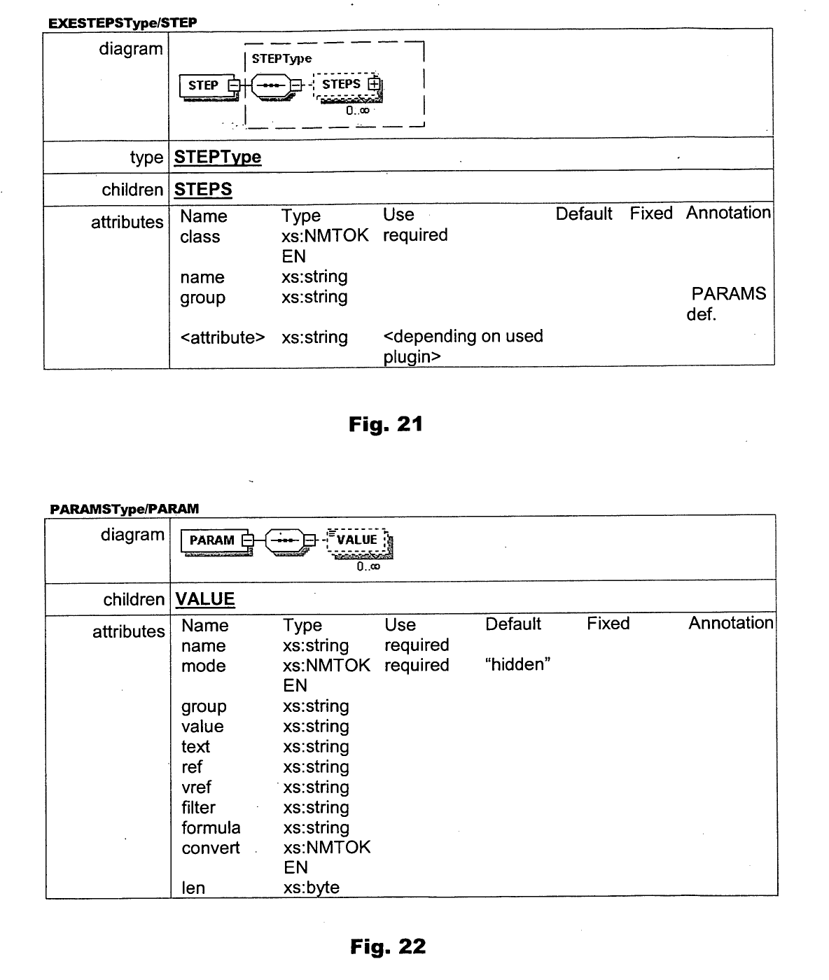

FIG. 22 depicts a diagram of the element PARAMSType/PARAM together with its child VALUE and its attributes.

The XML node PARAM is used to define single parameters and values for use in the Java Plugin classes. The “name=<value>” token is a mandatory entry for each parameter to be defined.

Additionally a built in “EditParamStep” dynamic user interface dialog for optionally viewing, changing and enhancing parameter values have to be defined in here using the “mode=<value>” token. The following list describes the available modes to be used here:
1.) hidden: Neither attribute name nor value will occur in the dialog. Value is predefined and cannot be changed by user interaction at this point.
2.) edit: This will lead to a text entry name/value field in the dialog. The parameter value will be shown and can be edited by the user
3.) constant: The parameter value will be shown but cannot be edited by the user. Value is predefined and cannot be changed by user interaction at this point.
4.) bool: The attribute is presented as a check box. The user may select or deselect it.
5.) enum: A list of predefined values is presented in a row of check boxes (RadioCheckButtons). The list of predefined defined values has to be defined as described under PARAMSType/PARAM/VALUE.
6.) combo: A list of predefined values is presented in form of a pull down menu (PullDownMenu). The list of predefined defined values has to be defined as described under PARAMSType/PARAM/VALUE.
7.) func: The value of the parameter should be calculated by a formula defined in the additional “formula” token. Name and value are not presented within the dialog.
8.) browse: like 2.) with an additional “File Browse” Button at the left hand side. Additionally a “filter=<value>” token may be defined to determine the file extension e.g.: “.zip” or “.pdf”
9.) descrsearch: like 2.) with an additional “Search” button at the left hand side to access document search functionality directly from the PLM system.
10.) part: like 2.) with an additional “Search” button at the left hand side to access component search functionality directly from the PLM system.
11.) “doclink”: like 2.) with an additional “Search” button at the left hand side to access attached document search functionality directly from the PLM system.

The value for the actual defined parameter may be determined/predefined in three different ways:
1.) value: A value will be given from the configuration. Whether it may be changed by user interaction or not is defined by the “mode=<value>” token. Using the group token the value may be tightly coupled towards specific steps.
2.) ref: No value will be entered here but a reference towards another defined parameter in form of: <Master Config name>.<Task name>.<parameter name> parameter changes from the dialog will in this case also affect the referenced parameter.
3.) vref: same as above—but is capable of referencing variant related parameters in form of: <Master Config name>.<Task name>.<parameter name> vref should only be used from and to tasks of type VARIANTTASK

All entries made by the user leading to a successful completion of a task will at the end be stored inside a product or project related file located in the base directory of the actually selected design product or project—so no information will be lost next time the user starts the integration.

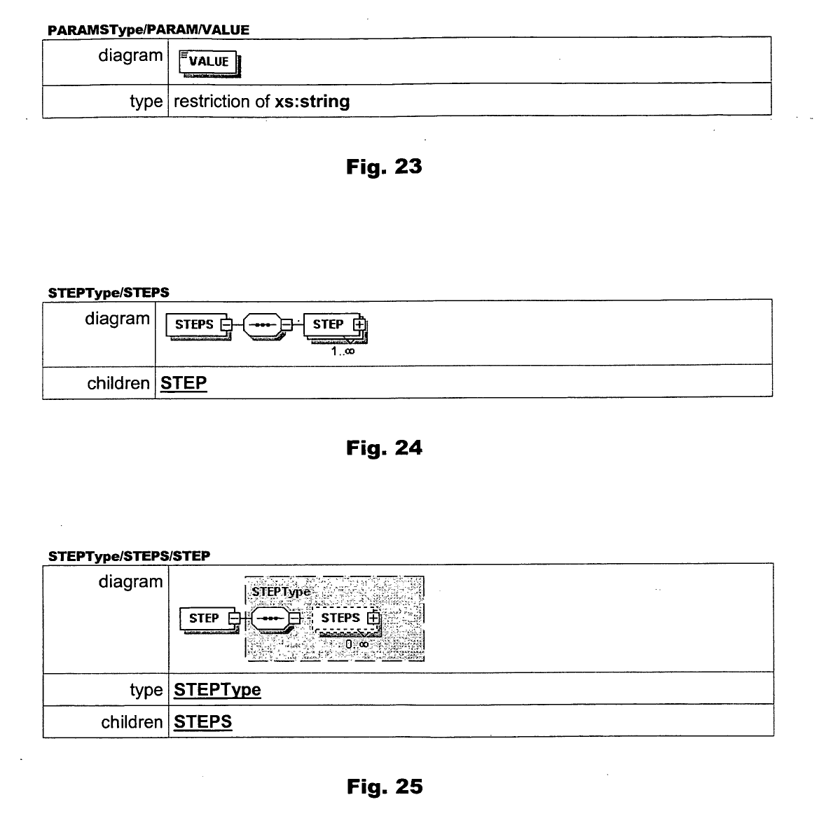

In FIG. 23, a diagram of the element PARAMSType/PARAM/VALUE is given, which is the restriction of a list of attribute values xs:string.

The XML node VALUE may consist of a default value as well as a set of values when using the PARAM “modes “combo” and “enum”. The format for a value list equivalents a list of XML sub nodes e.g.:

<VALUE>first</VALUE> <VALUE>second</VALUE>
<VALUE>third</VALUE>

In conjunction with “combo” and “enum” modes this would look like:

<PARAM name=“comboParam” mode=“combo” group=“edit”
value=“second”>

<VALUE>first</VALUE>
<VALUE>second</VALUE>
<VALUE>third</VALUE>

</PARAM>

FIG. 24 depicts a diagram of the element STEPType/STEPS which provides the child STEP.

The XML node STEPS defines the frame for a sequence of steps that need to be executed within a single step. This is typically used in conjunction with the “ifStep” Java Plugin class as shown in an example below:

<STEP class=“IfStep”>

<STEPS>

<STEP class=“ExecStep” name=“changeMat” cmd=“echo

Attempt to change material” />

<STEP class=“BapiStep” name=“bapi2” group=“bapi2”

func=“BAPI_MATERIAL_SAVEDATA”
descr=“Change Material”
check=“checkStructReturn” />

</STEPS>
<STEPS>

<STEP class=“ExecStep” name=“createMat” cmd=“echo

Attempt to create material” />

<STEP class=“BapiStep” name=“bapi2” group=“bapi2”

func=“BAPI_MATERIAL_SAVEDATA”
descr=“Create Material”
check=“checkStructReturn” />

</STEPS>

</STEP>

FIG. 25 shows a diagram of the element STEPType/STEPS/STEP which is of the type STEPType, provides the child STEPS and has the same characteristics as the element STEP.

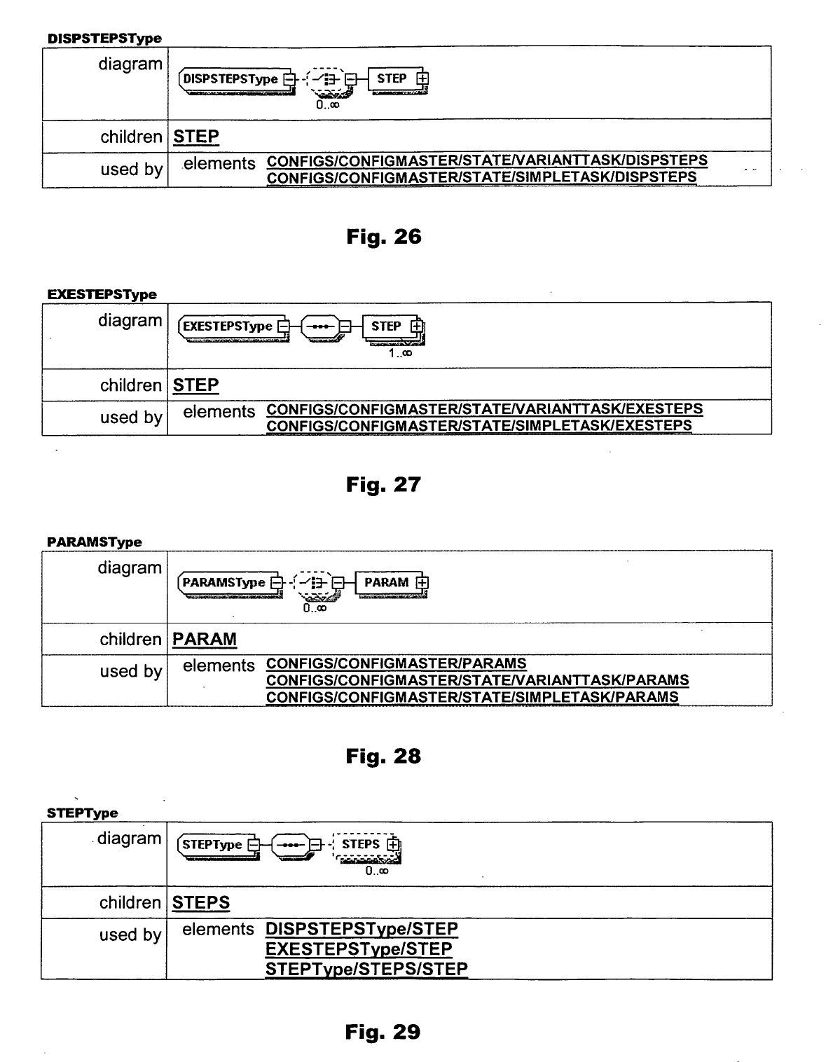

FIG. 26 depicts a diagram of the complex type DISPSTEPSType which provides the child STEP and is used by the elements CONFIGS/CONFIGMASTER/STATE/VARIANTTASK/DISPSTEPS and CONFIGS/CONFIGMASTER/STATE/SIMPLETASK/DISPSTEPS.

In FIG. 27, a diagram of the complex type EXESTEPSType is given which provides the child STEP and is used by the elements
CONFIGS/CONFIGMASTER/STATE/VARIANTTASK/EXESTEPS and
CONFIGS/CONFIGMASTER/STATE/SIMPLETASK/EXESTEPS.

A diagram of the complex type PARAMSType is given in FIG. 28. This complex type provides the child PARAM and is used by the elements
CONFIGS/CONFIGMASTER/PARAMS,
CONFIGS/CONFIGMASTER/STATE/VARIANTTASK/PARAMS and
CONFIGS/CONFIGMASTER/STATE/SIMPLETASK/PARAMS.

FIG. 29 shows a diagram of the complex types STEPType which provides the child STEP and is used by the elements
DISPSTEPSType/STEP,
EXESTEPSType/STEP and
STEPType/STEPS/STEP.

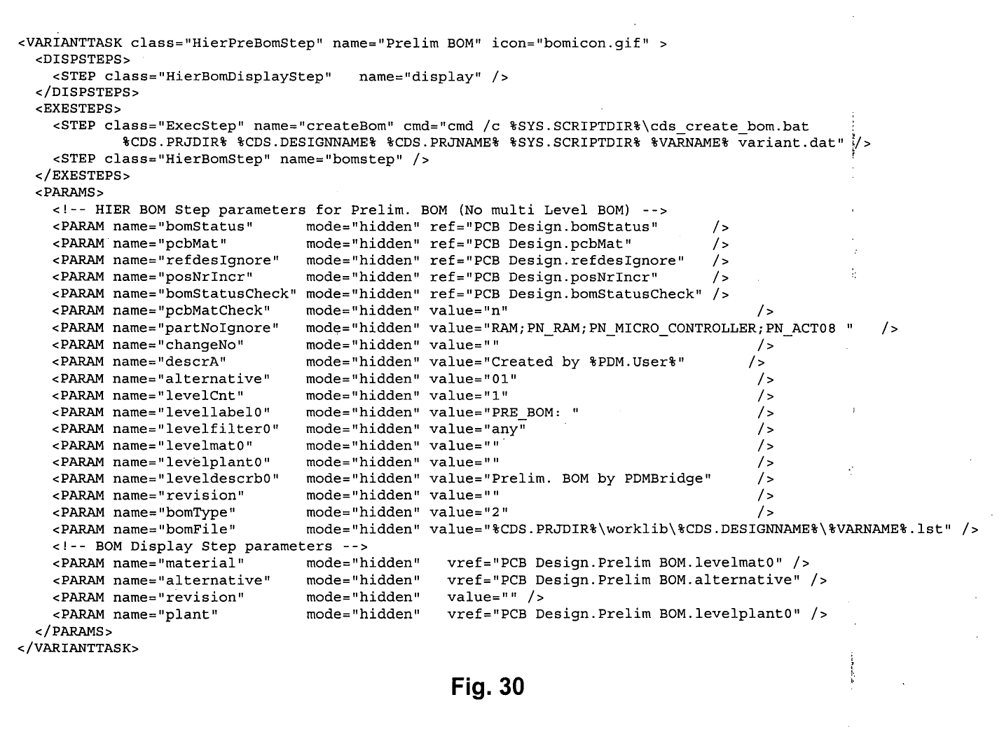

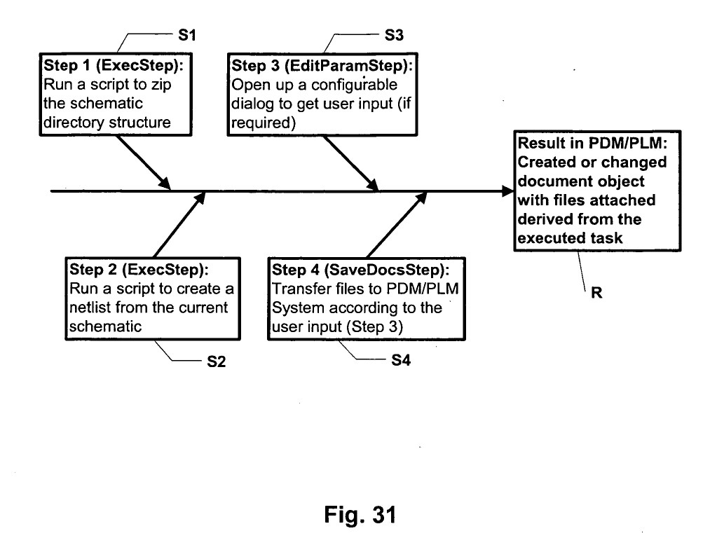

FIG. 30 shows the usage of the described XML definition language in a system or method according to the invention with the example of generating a part list or bill of materials (BOM).

The listing given in FIG. 30 comprises mainly three different steps: The first is the “HierBomDisplayStep”, which is a generic Java plugin class for visualizing part list structures. In order to be able to unambiguously identify materials of an most upper layer, four parameters are necessary: The material number identified by the parameter “material”, the part list alternative given by the parameter “alternative”, the part list revision identified by the parameter “revision” as well as the factory in which this part list is valid and which is identified by the parameter “plant”. These parameters are used at the bottom of the listing carrying the header “BOM Display Step parameters”.

The next step is the “ExecStep” which provides the generation of a part list based on the actually selected product or project in a format which can be read by a Java plugin class “HierBombStep”. This “ExecStep” provides an execution of system commands so that external processors can be invoked. The invokation of the external process might depend on the actually product or on the actually used computer platform so that product or platform dependent internal variables like “CDS.PRJDIR” or “CDS.DESIGNNAME” or “SYS.SCRIPTIR” can be supplied.

In a final step, the “HierBomStep”, the generated part list is transferred to a PDM or PDM/PLM system. The Java plugin class “HierBomStep” makes use of an internal process and is based on information and commands which are codified in parameters. These parameters are given in the block of the listing which is headed by “TEMIC BOM Step parameters for Prelim. Bom”. For example, the place or directory where the generated part list is stored is given by the parameter “bomFile”.

FIG. 31 schematically illustrates with another example the usage of the described XML definition language. In this example, the check-in of data created or changed by a user at a client, for example by the PBC layout designer at client 176 in FIG. 6, into the PDM/PLM server.

In a first step S1, which is an “ExecStep”, a script is run in order to zip or compress one or more schematic drawings belonging to a certain product or a directory structure containing such schematic drawings.

In the next step S2, which is again an “ExecStep”, a script is run in order to create a part list or so-called net list for this product from the current schematic drawing or schematic drawings.

In a third step S3, which is an “EditParamStep”, a configurable dialogue is opened which is realized by a user interface in order to give the end-user the possibility to provide data input if required.

The next step S4 is a “SafeDocsStep” in which files containing data of the schematic drawings as well as data entered by the end-user are transferred to the PDM/PLM system, whereas the data entered by the user in step S3 might influence the way and the kind of data which is transferred to the PDM/PLM system or server if such a possibility has been implemented in the user interface.

Consequently, as illustrated by the result R, documents, or document objects respectively, have been created or changed within the PDM/PLM server. Files, that have been generated and/or transferred to the PDM/PLM server due to the execution of processes realizing a defined task which covers the transfer and update of schematic drawings of the PCB layout designer, are attached to these documents or document objects in the PDM/PLM server.

### LIST OF REFERENCE NUMBERS

1 PDM server

1a PDM/PLM server

2 storing documents on PDM server

4 data exchange PDM server—interface I

6 data exchange PDM server—interface II

8 data exchange PDM server—interface III

10 data exchange PDM server—interface IV

12 data exchange interface I—ECAD

14 data exchange interface II—business administration

16 data exchange interface III—assembly/manufacturing

18 data exchange interface IV—external board supplier

20 client of division—ECAD

21 defining tasks

22 client of division business administration

23 defining tasks

24 client of division—assembly/manufacturing

25 defining tasks

26 client of division—external board supplier

28 transfer task definitions/instructions for process execution

30 transfer task definitions/instructions for process execution

32 transfer task definitions/instructions for process execution

34 transfer task definitions/instructions for process execution

40 translation of defined tasks into process execution instructions

42 configuration of interfaces

43 generation of user interfaces

44 forwarding of task definitions

45 storing of task definitions

46 interface I

47 interface II

48 interface III

49 interface IV

50 transfer configuration for interface I

52 transfer configuration for interface II

54 transfer configuration for interface III

56 transfer configuration for interface IV

60 transfer configuration and UI for interface I/UI-data

62 transfer configuration and UI for interface II/UI-data

64 transfer configuration and UI for interface III/UI-data

66 transfer configuration and UI for interface IV/UI-data

68 storing documents and lifecycle data in PDM/PLM server

80 PDM server

81 individually configured interface I

82 individually configured interface II

83 individually configured interface III

84 individually configured interface IV

86 connection

87 connection

88 connection

89 connection

90 client of division—ECAD

91 client of division—business administration

92 client of division—assembly/manufacturing

93 client of division—external board supplier

95 connection

96 connection

97 connection

98 connection

101a PDM system

101b PDM system

102 PDM server

104 connection

105 connection

106 connection

107 connection

110 connection

111 connection

112 connection

113 connection

115 connection

116 connection

117 connection

118 connection

120 client of division—ECAD

122 client of division business administration

124 client of division—assembly/manufacturing

126 client of division—external board supplier

130 connection

131 connection

132 connection

133 connection

140 configuration engine

141 configuration engine

146 interface I

147 interface II

148 interface III

149 interface IV

160 connection

161 connection

162 connection

163 connection

170 PDM/PLM server

171 PDM/PLM server

173 web-server

175 client of schematic designer

176 client of PCB layout designer

177 client of ECAD project manager.

181a connection for obtaining data

181b connection for providing data

182a connection for obtaining data

182b connection for providing data

183a connection for obtaining data

183b connection for providing data

185 graphical user interface

190 connection web-server PDM/PLM server

191 editable field

192 editable field

192 editable field

193 editable field

194 editable field

195 editable field

196 editable field

197 editable field

198 editable field

199 editable field

S1 first step

S2 second step

S3 third step

S4 fourth step

R result

1. Product data management (PDM) method comprising the steps of:
Storing at least one document associated with a product in at least one PDM server (2);
exchanging data (4, 6, 8, 10, 12, 14, 16, 18) between the at least one PDM server (2) and clients (20, 22, 24, 26) of divisions via at least one interface (46, 47, 48, 49) per division;
defining tasks (21, 23, 25) for managing product data using a descriptive language;
automatically translating (40) defined tasks into corresponsing process execution instructions for clients (20, 22, 24, 26) of the divisions concerned by at least one defined task;
automatically configuring (42) interfaces (46, 47, 48, 49) belonging to devisions concerned by at least one defined task for according to this at least one 20 defined task necessary data exchange (4, 6, 8, 10, 12, 14, 16, 18) between clients (20, 22, 24, 26) of these concerned divisions and the at least one PDM server (2).

2. PDM method according to claim 1 further comprising defining of tasks (21, 23, 25) using an extended markup language (XML) as descriptive language.

3. PDM method according to claim 1 further comprising automatically generating according to defined tasks user interfaces (43), in particular graphical user interfaces, for the entering of data within at least one interface (46, 47, 48, 49).

4. PDM method according to claim 3 further comprising storing of data (45) entered in at least one user interface and displaying this data as preselection values when this at least one user interface is invoked the next time.

5. PDM method according to claim 1 further comprising managing of product related life cycles (PLM) and corresponding data in the same way as documents associated with this product.

6. Product data management (PDM) system comprising:
a PDM server (102);
clients (120, 122, 124, 126) of divisions;
at least one interface (146, 147, 148, 149) per division connecting the at least one PDM server (102) with at least a part of the clients (120, 122, 124, 126) of the divisions;
a configuration engine (140) connected to at least a part of the interfaces (146, 147, 148, 149) and at least a part of the clients (120, 122, 124, 126) of the divisions;
whereas the configuration engine is provided for:
receiving tasks definitions given in a descriptive language,
automatically translating received task definitions into corresponding process execution instructions for at least a part of the clients (120, 122, 124, 126) concerned with at least one received task definition,
automatically configuring at least a part of the interfaces (146, 147, 148, 149) concerned with at least one received task definition for according to these defined task necessary data exchange between clients (120, 122, 124, 126) connected to the concerned interfaces (146, 147, 148, 149) and the PDM server.

7. The system of claim 1, wherein the configuration engine (140) is capable of receiving task definitions given in extended markup language (XML) as a particular descriptive language.

8. The system of claim 1, wherein the configuration engine (140) is capable of automatically generating according to defined tasks user interfaces, particularly graphical user interfaces, for the entering of data within at least one interface (146, 147, 148, 149).

9. The system of claim 8, wherein the data entered in at least one user interface is stored and displayed as preselected data the next time this at least one user interface is invoked.

10. The system of claim 1, further comprising a product life cycle management (PLM) server being bi-directionally connected to the at least one PDM server (170) or integrated in the at least one PDM server (170).

11. The system of claim 1, wherein task definitions can be made in at least one client (120, 122, 124, 126) of at least one division.

12. The system of claim 1, wherein at least a part of the interfaces (146, 147, 148, 149) is integrated into the at least one PDM server (102).

13. The system of claim 1, wherein the configuration engine (140, 141) is integrated into the at least one PDM server (102).

14. The-system of claim 1,-wherein at least a part of the interfaces (146, 147, 148, 149) is formed by web-servers (173) which are connected to the at least one PDM server (170).
